(19) United States
(12) Patent Application Publication
(10) Pub. No.: US 2026/0140981 A1
(43) Pub. Date: May 21, 2026

(54) METHOD AND SYSTEM FOR QUESTION-ANSWERING BY GENERATIVE ARTIFICIAL INTELLIGENCE BASED ON A KNOWLEDGE GRAPH

(71) Applicant: Orange, Issy-les-Moulineaux (FR)

(72) Inventors: Yoan CHABOT, CHATILLON CEDEX (FR); Antoine PY, CHATILLON CEDEX (FR); Viet-Phi HUYNH, CHATILLON CEDEX (FR)

(21) Appl. No.: 19/395,427

(22) Filed: Nov. 20, 2025

(30) Foreign Application Priority Data
Nov. 20, 2024 (FR) FR2412710

(51) Int. Cl. G06F 16/3329; G06F 16/338

(52) U.S. Cl. CPC G06F 16/33295; G06F 16/338

(57) ABSTRACT

A user interface for a question-answering system, the user interface including: a module for entering questions in natural language; and a presentation module configured to present: an answer generated by a question-answering engine using a natural language processing model, a representation of entities collected by the system when generating the answer, and a representation of a knowledge graph portion including the entities collected and their neighborhoods.

### CROSS-REFERENCE TO RELATED APPLICATION

This application claims foreign priority to FR 2412710, filed Nov. 20, 2024, the contents of which is incorporated by reference herein in its entirety.

### BACKGROUND

### Field

This disclosure relates to the field of question-answering systems. More specifically, it relates to a user interface, as well as to a corresponding question-answering system, corresponding method of providing the same, and corresponding computer program.

### Description of the Related Technology

Automated question-answering (Q/A) systems based on artificial intelligence (AI) are widely used to understand user questions and generate relevant answers. These systems commonly rely on natural language processing models (LLM), which, while effective for rapid and tailored answers, have certain limitations. These models, which are often static after training, may lack accuracy on recent or specific topics.

To address these shortcomings, approaches such as retrieval-augmented generation (RAG) have been developed. They allow integrating up-to-date data coming from external corpora of documents. However, these approaches remain limited in their ability to connect disparate information and exploit less direct relationships between concepts. The GraphRAG approach partially overcomes this limitation by using knowledge graphs, which allow a more contextual association of entities and the enrichment of answers. However, even these advanced techniques struggle to provide satisfactory interactivity with the underlying databases.

In this context, there is a need for a solution that allows a user of a question-answering system to explore knowledge relevant to a question asked.

### SUMMARY

The present disclosure improves the situation.

According to one aspect, a user interface for a question-answering system is provided, comprising: a module for entering questions in natural language, a presentation module configured to present: an answer generated by a question-answering engine using a natural language processing model, a representation of entities collected by the system when generating the answer, and a representation of a knowledge graph portion comprising the entities collected and their neighborhoods.

This interface offers several advantages. It facilitates the understanding and verification of answers, by presenting a representation of the entities collected in generating the answer. By presenting a representation of the knowledge graph, it also allows exploring knowledge relevant to the question asked.

According to another aspect, a method is proposed for providing an answer to a question asked in natural language, the method being implemented by a user interface of a question-answering system and comprising: a presentation of an answer to a question entered in natural language, the answer being generated by a question-answering engine using a natural language processing model, a presentation of a representation of entities collected by the system during generation of the answer, and a presentation of a representation of a knowledge graph portion comprising the entities collected and their neighborhood.

According to another aspect, a computer program is provided comprising instructions which, when the program is implemented by a processor, lead to implementing the method as defined herein. According to another aspect, a non-transitory computer-readable storage medium is provided on which such a program is stored.

The features described in the following paragraphs may optionally be implemented, independently of one another or in combination.

In one example, the presentation module is configured to present the answer progressively, as it is generated by the question-answering engine.

By progressively displaying the answer, the user can begin reading and understanding, starting with the very first elements, which improves the user experience by reducing the perception of latency.

In one example, the representation of the entities collected comprises interactive links to pages detailing information associated with the entities.

The links allow the user to deepen their understanding by directly accessing additional sources of information. Furthermore, users can easily navigate between concise and detailed information, which improves the interactivity and precision of the exploration.

In one example, the representation of the knowledge graph portion comprises interactive links to pages detailing information associated with the entities and their neighborhoods.

The ability to click on elements of the graph and access information related to the entities' neighborhoods can facilitate a deeper understanding of the entities' relationships and contexts of use.

In one example, the pages comprise indications of the information sources.

The presence of sources ensures increased transparency, which can allow verifying the origin of the information, which improves the credibility of the answers provided.

In one example, the interface comprises a module for editing information on the pages.

This functionality can contribute to the dynamic and collaborative growth of a knowledge base linked to the knowledge graph, and to improving subsequent answers provided by the question-answering system.

In one example, the representation of the entities includes descriptive labels and/or text descriptions of the entities.

Labels and text descriptions allow quickly and clearly identifying the entities, which can facilitate understanding and reduce the need for additional navigation.

In one example, the interface comprises a module for selecting a number of neighborhood levels in the knowledge graph portion.

In one example, the interface comprises a module for entering feedback associated with the entities collected.

### BRIEF DESCRIPTION OF THE DRAWINGS

Other features, details and advantages will become apparent from reading the detailed description below, and from analyzing the attached drawings, in which:

FIG. 1 shows a question-answering system in an exemplary embodiment.

FIG. 2 shows a user interface of such a system, in an exemplary embodiment.

FIG. 3 shows a page detailing information associated with an entity represented on such a user interface, in an exemplary embodiment.

### DETAILED DESCRIPTION OF CERTAIN ILLUSTRATIVE EMBODIMENTS

According to one aspect, the proposed technique relates to a user interface suitable for a question-answering system. This user interface is designed to facilitate a user's exploration of knowledge relevant to a question asked, and to facilitate the collaborative use and enrichment of a knowledge base containing this relevant knowledge.

Some specific terms are now clarified for a better understanding of the proposed technique.

A question-answering (Q/A) system is a computer system capable of receiving questions formulated by a user, analyzing them, and generating answers. This type of system makes use of internal or external knowledge to provide precise and relevant answers. The system is based on one or more natural language processing models coupled with one or more structured knowledge bases. The questions and answers are formulated in natural language. A question or answer in natural language is worded in a fluid and human-understandable manner, as it would be asked in a conversation. The system may be designed to interpret and answer natural language questions without requiring any specific technical syntax or keywords, making its use accessible to a wide audience.

A user interface suitable for such a question-answering system is an interactive platform that allows the user to interact with the system. It may be implemented as a web, mobile, or other application, and may include graphical and voice-based elements for entering questions and providing answers. Depending on the context, the interface may include customization elements and options for adjusting the presented information.

An input module for capturing natural language questions is a software entity within the user interface whose function is to allow the user to ask questions in natural language. It may comprise a text field, where the user directly enters their question, or a voice module that transcribes spoken questions into text via a speech recognition system. Such a module may also include options for specifying parameters, such as the expected level of detail in the answer, the desired type of answer (e.g. an explanation, a summary, a recommendation, a list, etc.), a desired level of complexity, a preferred data source (e.g. a particular topic, a particular database), etc.

A presentation module is a software entity of the user interface, responsible for providing the user with answers to questions asked. It presents the answer in a clear and understandable form, in natural language, and may also display additional information.

A question-answering engine is a software entity based on a natural language processing model, for example a large language model (LLM). It is designed to interpret questions asked by means of the input module, search for relevant information in one or more knowledge bases, and call upon the natural language model to obtain answers to the questions asked by relying on the relevant information found. The question-answering engine then transmits the obtained answers to the presentation module.

A natural language processing model is a machine learning model capable of understanding and processing queries comprising natural language questions and complementary information, in order to produce coherent answers. Such a model, based on one or more neural networks, may, for example, be able to identify entities in the questions, interpret the context of use of these entities in the questions, and/or generate answers to the questions.

In the context of the proposed technique, the question-answering system (and more specifically the question-answering engine) may be implemented by an organization having one or more internal knowledge bases. An internal knowledge base is a structured data repository maintained by the organization implementing the question-answering system. It contains information specific to and often exclusive to the organization, such as internal documents, technical files, reports, answers to frequently asked questions, or project descriptions. It may also contain structured information about concepts or entities specific to the organization, for example technologies, products, and/or internal skills. Generally, the data in this database are regularly updated to reflect current knowledge and internal developments. This internal knowledge base is often used to answer questions asked by users by making use of information specific to the organization, which distinguishes it from an external knowledge base.

The natural language models currently in use are implemented by service providers and use external knowledge bases, which may be public or owned by these service providers, to generate answers to questions. An external knowledge base is a repository of data that is public or accessible via sources external to the organization that owns the question-answering system. It may include information from public resources, such as encyclopedias, academic databases, research articles, blogs, or news. The data in an external knowledge base is often general and may be used to enrich answers by providing additional information not specifically available in the internal knowledge base. It is particularly useful for information in the general domain or for up-to-date knowledge that is not necessarily part of the organization's internal knowledge.

A knowledge base, whether internal or external, contains various types of information organized so as to be easily accessible and usable by the question-answering engine. Information may be organized in various formats, such as tables, ontologies, or hierarchical schemas, and for example may include text, images, videos, sounds, etc. A knowledge base may include entities which represent objects, concepts, or people having a specific significance in a given domain. For example, in a telecommunications company, entities may be technologies (e.g. SD-WAN), projects, teams, products, etc. A knowledge base may include relationships, which define the links between entities. For example, a relationship might indicate that a technology is used in a particular project, or that an expert belongs to a specific team. A knowledge base may include attributes, which are specific characteristics of entities, such as text descriptions, important dates, links to documents or images. A knowledge base may include text documents associated with the entities and relationships.

A knowledge graph is a structured representation of the data contained in a knowledge base. In some implementations, rather than separating internal and/or external knowledge bases, these bases may be unified into a single knowledge graph, for example securely hosted on a centralized platform. This unified graph makes it possible to avoid the transfer of sensitive data while providing a comprehensive view of entities and relationships.

The knowledge graph organizes entities and their relationships semantically, facilitating searches and the contextual understanding of information. In a knowledge graph, each entity is represented by a node. Relationships between entities are represented by edges connecting the nodes. These relationships can express different types of relationships, such as hierarchical (e.g. “belongs to”), functional (e.g. “uses”), temporal (e.g. “created on”), or other types of semantic relationships. The knowledge graph may be organized into different layers, with each layer representing, for example, a different level of detail or degree of confidentiality. The question-answering engine may be configured to select the appropriate layer on the basis of one or more criteria, such as the user profile or the desired level of detail in the answer.

A proximity distance between two distinct entities in the knowledge graph may be defined as follows:
Two entities A and B directly connected by an edge have a proximity distance of 1,
Two entities A and C indirectly connected via an entity B by a first edge A-B and a second edge B-C have a proximity distance of 2,
Two entities A and D indirectly connected via two entities B and C by a first

edge A-B, a second edge B-C, and a third edge C-D have a proximity distance of 3, etc.

The knowledge graph allows the question-answering engine to navigate contextually between entities, while identifying connections that enrich the answer to a question. For example, if a user asks a question about a specific technology, the engine can explore the neighborhood of this technology in the graph to include additional information, such as associated projects, expert teams, and documentation resources. In most graphical user interfaces, a knowledge graph is displayed as nodes and edges, allowing for interactive exploration. The user can navigate the graph by clicking on entities and exploring their relationships, which is particularly useful for screen-based interfaces. Although knowledge graphs are often displayed graphically, other representations and modalities of interaction are possible. For voice or text-based interfaces (such as voice assistants), the knowledge graph may be presented in a textual form where relationships are described verbally or textually. For example, the system might state: “SD-WAN technology is used in projects X and Y, and is managed by team A.”

The question-answering system may integrate a module implementing a proprietary or local natural language model. This allows the content of at least one internal database to be used to process questions while avoiding the transmission of sensitive information to an external service provider.

Conversely, in a configuration where the organization that owns the question-answering system and the internal knowledge base(s) is separate from the service provider providing the module implementing the natural language processing model and the external knowledge bases, it may be necessary to limit the transmission of sensitive information from the internal knowledge base to the module implementing the natural language processing model. To meet this confidentiality requirement, communication between the question-answering engine and the module implementing the natural language processing model may be carried out via an API (application programming interface). More specifically, the question-answering engine may be configured to send an API request to the module implementing the natural language processing model. This request includes the question asked by the user, as well as relevant entities and/or relationships taken from the internal knowledge base. This allows the module implementing the natural language processing model to contextualize the answer based on relevant information, without requiring the transmission of detailed attributes or sensitive data from the internal knowledge base to the external service provider.

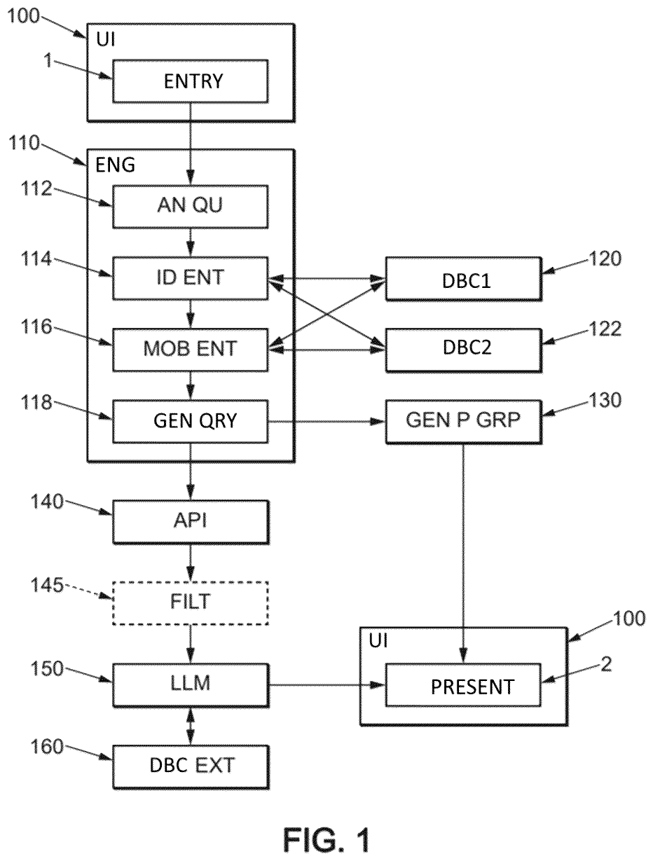

The question-answering system may, for example, comprise, as illustrated in FIG. 1:
a user interface 100 comprising an input module 1 and a presentation module 2,
a question-answering engine 110,
at least one knowledge base 120, 122, and
a generator of a knowledge graph portion 130.

The question-answering engine may be coupled, for example via an application programming interface 140, to a module 150 implementing the natural language model, said module 150 using at least one external knowledge base 160.

An example of one possible operation of such a question-answering system is now detailed.

The user enters a question in natural language via the input module 1. Once the question is submitted, the question-answering engine 110 processes the question by using relevant entities and/or relationships, taken from the at least one knowledge base 120, 122, in order to query module 150.

The generator 130 may further generate a knowledge graph portion of the at least one knowledge base comprising all or part of the entities collected. The knowledge graph may be pre-generated across the entire database, and the generator may be configured to select a specific portion of the pre-generated knowledge graph. Alternatively, the knowledge graph portion may be dynamically generated for each question asked, based solely on the entities relevant to the question asked.

The answer generated by module 150 is returned by the presentation module 2, with all or part of the entities and/or relationships used by the question-answering engine and/or with the knowledge graph portion generated by the generator 130.

An example of one possible architecture of the question-answering engine 110 is now detailed, as well as an example of its operation. In this configuration, the management and security of the entire question-answering system is ensured by a single organization.

The question-answering engine may, for example, comprise:
a question analyzer 112,
an entity identification module 114,
an entity collection module 116, and
a query generator 118.

The question analyzer 112 is designed to interpret the question asked by identifying relevant elements, such as keywords. For example, the analyzer may comprise a natural language processing module for semantically interpreting the question. For example, the question analyzer may comprise a syntactic analysis module to structure parts of the question into key syntactic elements. The question analyzer is configured to transmit the identified elements to the entity identification module.

In some configurations, the question analyzer may be designed to determine whether the question asked falls within a domain covered by a specific knowledge base. Based on this assessment, the processing of the question may differ in how it is directed. For example, if the question relates to a domain corresponding to the entities of a knowledge base concerning a specific topic, such as telecommunications, the processing may continue by making use of only the relevant entities in that base. On the other hand, if the question is outside the scope of an available knowledge base, in such case the system may directly query a natural language processing model to generate an answer, without generating any list of entities collected or any knowledge graph portion. When several knowledge bases cover different topics, a preliminary selection of the most relevant base may be made, such that only that one is used for the entire process of processing the question asked.

The entity identification module 114 is designed to identify entities in one or more knowledge bases 120, 122. It may collaborate with the entity collection module 116 to broaden the search to entities having a relationship to those identified. In certain configurations, the entity identification module and the question analyzer may be combined into a single question comprehension module, particularly when the engine was previously configured to operate, within the context of processing the question asked, within a restricted context with well-defined entities.

The entity collection module 116 is configured to extend entities extracted from the knowledge base to their neighborhood, identifying entities linked to those previously identified by the identification module, via relationships in the knowledge graph of the at least one knowledge base. The collection module may be omitted when the answers do not require an extended context or when the relationships between entities are not relevant to the answer. It may be replaced by a contextual simplification module, in order to limit itself to the most directly relevant entities and exclude secondary relationships. The identification module 114 and the collection module may also be combined into a single module.

The query generator 118 is configured to generate a query intended for module 150. The query generator may be combined with a syntactic formulation module in order to formulate the query in a specific query language or according to a predefined syntax.

The query may comprise, for example, the question asked and a “list of entities collected” which is a list comprising at least the entities identified by the identification module 114 and may further comprise the entities identified by the collection module 116.

The query may comprise the question asked, the identified entities, and a proximity depth level of the identified entities in the corresponding knowledge graph. This approach allows the entity collection module 116 to be omitted and its function to be assigned to module 150.

The query may include, in addition to the question asked and the entities collected, one or more of the following elements:
one or more links to the pages of the entities collected in the corresponding knowledge base,
specific attributes of each entity collected, such as text descriptions, contextual information, or metadata, these attributes being retrieved on the fly from the corresponding knowledge base,
relationships or links, for example hierarchical or functional links, between the entities collected, and
a summary of information associated with the entities collected, in the form of structured metadata, which the module 150 can use for a faster and more targeted interpretation.

The query is provided to module 150 so that module 150 uses or “collects” at least the entities specified in the query, to generate an answer.

Alternatively, module 150 may be directly integrated into the question-answering engine and may be configured to interpret the question, identify the entities in the knowledge base(s), and provide the answer to the question asked, without it being necessary to provide the natural language model with an intermediate query containing information other than the text of the question asked.

Furthermore, the list of entities collected may be provided to the generator 130 which is configured to generate a knowledge graph portion comprising at least these entities and their contextual relationships.

The presentation module 2 gathers and presents the answer, enriched with the list of entities collected and/or with the generated knowledge graph portion.

In an alternative configuration, the question-answering system uses an external natural language model with confidentiality requirements. In such a configuration, a filtering module 145 may be provided, responsible for reversibly or irreversibly anonymizing (e.g. masking), or filtering the queries sent to module 150. This module may be interfaced in different ways within the question-answering engine, depending on the steps in processing the question.

For example, the filtering module may be configured to directly receive the question asked before it is analyzed. It anonymizes any sensitive data present in the question, such as names of specific entities or sensitive information from the knowledge base.

For example, the filtering module may be configured to receive the elements of the question identified by the question analyzer. It filters or anonymizes keywords deemed confidential before transmitting them to the identification module.

For example, the filtering module may be configured to receive the labels and/or attributes of the entities identified by the identification module or by the collection module. It filters or anonymizes these labels and/or attributes before transmitting them to the query generator.

For example, the filtering module may be configured to receive the query generated by the query generator and containing entity labels and/or attributes. It filters or anonymizes these labels and/or attributes before transmitting them to the module implementing the natural language model.

When the anonymization of entity labels or attributes is reversible, a de-anonymization module may be provided for receiving the answer provided by the module implementing the natural language model and processing this answer by de-anonymizing the anonymized labels or attributes it contains before providing the processed answer to the presentation module.

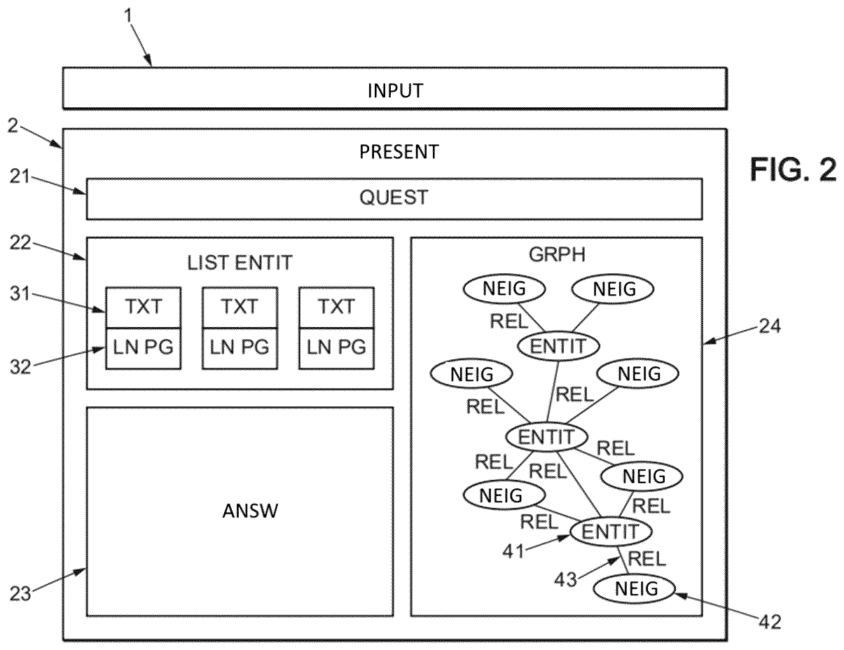

FIG. 2 illustrates an example user interface for a question-answering system based on a knowledge graph. The user interface may be implemented by a variety of devices such as computers, tablets, smart phones, or voice assistants. Depending on the device used, the interface may vary in order to adapt to the constraints and possibilities of each medium. On a desktop computer, the user interface may include detailed graphical elements, interactive graph displays, and advanced navigation options such as zooming, panning, and rotating. Customization options are also possible, such as adjusting the colors or size of displayed elements to optimize the user experience. On a smart phone or tablet, interface elements may be simplified to adapt to screen size constraints. For example, viewing the knowledge graph may include a touch-based zoom, allowing the user to easily explore specific sections of the graph. A scroll bar or zoom icons (“+” and “−”) may also be added. For voice interaction, the user interface guides the user with audio instructions and provides answers in the form of text-to-speech. Knowledge graph information may be presented as narrative descriptions, to facilitate understanding without a graphical display.

The user interface comprises the input module 1 and the presentation module 2.

The input module 1 is designed to allow the user to ask questions in natural language. The input module may allow various input modes, such as a text box in which the user can freely enter a question and/or a voice input field allowing speech recognition to be used to transcribe the spoken question into text. In the latter case, the user may, for example, tap a microphone icon to start and stop voice recording. In one example of an input mode, a file import area may be provided. The user may drag a file to such an area, the file possibly containing additional information. The system may then extract relevant information from the file to enhance its understanding of the question.

The input module may include options for modifying or specifying parameters of the question. For example, a command may be provided for selecting a search domain (e.g. “telecommunications,” “health,” etc.) in the knowledge graph. For example, a command may be provided to select a desired level of detail in the answer (e.g. “concise” or “detailed”) before finalizing the question entry.

The presentation module 2 is subdivided into several sections:
a section 21 for presenting the entered question,
a section 22 for presenting a list of entities collected when generating the answer to the entered question,
a section 23 for presenting an answer to the entered question, and
a section 24 for presenting a knowledge graph portion associated with the entities in the list of entities.

The presentation module may allow various modes of presentation adapted to the features and/or constraints of the device(s) used and/or to the user's preferences and/or needs. For example, the mode of presentation may vary depending on whether the user desires a concise or detailed answer. For example, the mode of presentation may be textual, graphical, and/or voice. The module may offer filters, formatting options, contextual navigation controls, for example buttons for navigating between sections and/or within a section and/or shortcuts for switching between different desired levels of detail in the answer, etc.

Section 21 is configured to present the question entered by the user. This functionality provides context for the answer by showing the exact wording used to generate the answer. Depending on the implementation, this section may also include a quick edit feature, allowing the user to rephrase or refine their question without leaving the user interface. For example, clicking on the displayed question may open an editable text field containing the question heading, allowing the user to modify the question directly. A “Rephrase” button may also be provided, and interacting with this button causes the question-answering system to propose alternative versions of the question.

Section 23 is configured to present the answer to the question asked. The answer may be generated dynamically by a question-answering engine using one or more natural language processing models, such as a large language model (LLM), for example the engine of the question-answering system illustrated in FIG. 1. The answer may, for example, be streamed progressively, displaying the information as it is generated, allowing the user to see the answer being constructed in real time. This functionality may be accompanied by a loading animation to signal that the generation of the answer is in progress. Interactive buttons may be provided, such as an “expand answer” button, interaction with such a button causing a supplementary answer to be generated which provides additional details based on related concepts.

Section 22 is configured to present a list comprising the entity(ies) that were collected by the question-answering system in order to generate the answer. Each entity may be represented by a label 31 and a link 32, for example a hyperlink, to a detailed page. The representations of the presented entities may for example be organized in an ordered list or in a grid. Filters may be integrated to allow the representations of the presented entities to be sorted by category.

The labels 31 allow easily identifying each entity involved. The links 32 redirect to individual pages where the user is able to explore in-depth information about each entity. For example, in a business use case, if an entity is a specific technology concept or project, the link may direct the user to one or more internal pages documenting that concept or project. This level of detail allows obtaining a deeper understanding of the answer and navigating to additional relevant information.

In some embodiments, a first interaction with a link 32 may result in displaying a preview of all or part of the entity's detailed page, and a second interaction with the same link 32 or with the preview may result in displaying the detailed page in its entirety.

In addition, in section 23, certain parts of the answer may be interactive, for example parts of the answer explicitly referring to one of the entities collected or to a relationship between such an entity and a neighboring element in the graph. For example, it may be provided that the answer contains an interactive label 31 of an entity represented in section 22 and that interacting with the label 31 in section 22 or in section 23 causes the descriptive page of the entity to be opened.

Section 24 is configured to present a knowledge graph portion that is focused on the entities 41 used and their neighborhood 42. This representation, for example graphical, includes nodes for the entities and edges which represent the relationships 43 between these entities.

Several types of interactions may be provided with section 24, allowing easy manipulation of the graph and enhanced exploration of the relationships between entities. The interactions may include:
an interaction with a node,
an interaction with a relationship,
a global interaction with several nodes, for example all nodes, and/or several relationships, for example all relationships,
an interaction with the entire graph portion and/or with section 24 as a whole. Different types of actions may be performed, depending on the element concerned.

An interaction with a node may apply various effects, for example:
centering the graph portion on the node,
changing a color of the node,
hiding the node,
showing or hiding the node label,
opening or closing a page of the entity associated with the node,
showing or hiding a preview of the page of the entity associated with the node,
adjusting the position of the node in the graph portion, and/or
changing the size of the node, etc.

An interaction with a relationship may apply various effects, for example:
hiding the relationship,
changing a color of the relationship,
highlighting the relationship, and/or
showing or hiding a description of the relationship, etc.

An interaction with a node or a relationship may, for example, apply a same effect to all nodes or to all nodes of the same type as the node concerned, or a same effect to all relationships or to all relationships of the same type as the relationship concerned.

For example, an interaction with a node may apply a same effect to all of that node's relationships with its neighbors.

An interaction with a relationship may, for example, apply a same effect to the nodes linked by that relationship.

Interactive navigation may be provided which allows the user to interact with nodes to further explore associated entities or to view specific details. For example, zoom and navigation features may be provided which allow the user to adjust the size and location of the presented portion of the knowledge graph in order to explore specific sections of the graph. Such functionality is particularly useful in dense or large graphs. This functionality may be provided, for example, by means of “+” and “−” buttons, a scroll bar, or by means of touch commands such as holding two fingers on a portion of the graph and spreading them apart to zoom in or bringing them together to zoom out.

Filters may be provided to allow the user to filter the types of relationships represented, such as hierarchical or functional relationships between entities. Different colors may be used to indicate the types of relationships represented. The size of the nodes may be adjustable. A slider for the proximity depth level displayed may be provided, which allows displaying connected entities to several levels of relationship (also called depth, or proximity distance), to give the user a more or less extensive contextual view. The graph portion may be displayed in different connection layers, showing only primary relationships, i.e. with a proximity distance of 1, in an initial view, and additional connection layers showing secondary, tertiary, etc. relationships in subsequent views.

Interactions between section 24 and other sections of the interface may be provided.

For example, an interaction with a particular entity from section 22 or section 23 may apply an effect (e.g. highlighting) to the node corresponding to that entity in section 24 and/or to the edges corresponding to the relationships of that node with its neighborhood.

In some embodiments, the user may click and drag an element from one section of the user interface to another section of the user interface.

For example, a label of an entity appearing in section 23 may thus be moved to the graph presentation section 24 in order to add it to or isolate it in the graph, which may, for example, allow the presented graph portion to be adjusted to focus on that entity and its immediate neighborhood. For example, it may be provided that clicking on the label of an entity in section 22 or 23 would highlight the corresponding entity in section 24.

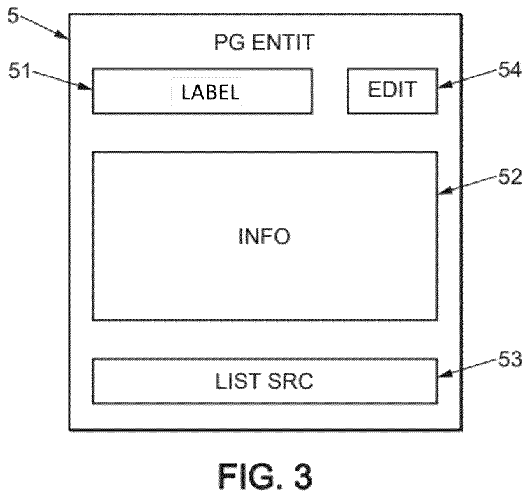

Reference is now made to FIG. 3, which illustrates the interface 5 of a page dedicated to a specific entity in the question-answering system. This interface allows the user to explore and modify the information associated with an entity, with a presentation structure and functionalities that may, for example, be similar to those of a typical Wikibase page.

The interface of FIG. 3 comprises the label 51 of the entity at the top of the page, and one or more attributes 52, 53.

For example, the attributes may comprise one or more of the following:
at least one property of the page (e.g. a creation date, a status, an author, etc.),
at least one alias of the entity in at least one language,
at least one property 52 describing the entity,
at least one relationship with a neighboring entity in the knowledge graph,
at least one property of such a relationship (e.g. a relationship type),
at least one knowledge source 53 or reference relating to at least one of the other attributes, for example in the form of a link or hyperlink to a page detailing content from the knowledge source or reference.

The interface may comprise interactive elements 54, for example a button to create a new entity page, as well as one or more editing buttons to modify the label on a page and to add, modify, or delete attributes in a page.

### INDUSTRIAL APPLICATION

These technical solutions may be implemented in various industrial contexts, in particular for internal use within an organization, in order to facilitate the access, management, and exploration of technical, strategic, or organizational knowledge.

Some illustrative examples of applications within an organization are presented below.

These technical solutions may be deployed to provide colleagues with interactive and centralized access to critical information, such as ongoing projects, technologies used, or adopted standards. The use of an intuitive interface based on a knowledge graph allows contextual navigation, thus simplifying the search for complex information.

These technical solutions may be deployed to consolidate and visualize strategic projects, their interdependencies, the teams involved, key contacts, and associated deliverables. Such a comprehensive view encourages informed decision-making and improves the monitoring of priority initiatives.

These technical solutions may be deployed when the information about teams, their skills, and their achievements is centralized, in order to facilitate identifying internal experts, encourage cross-team collaboration, and strengthen organizational synergies.

These technical solutions may be deployed to help sales and support teams quickly access relevant data about products, services, or projects carried out for specific clients. Such responsiveness improves the personalization of interactions and customer satisfaction.

These technical solutions may be deployed to simplify onboarding new employees and training teams, by providing them with clear access to internal knowledge bases. This allows exploring the relationships between an organization's concepts, tools, and procedures, thereby reducing the time to adapt.

Some other illustrative application examples, not necessarily concerning use within an organization, are presented below.

These technical solutions may be used to navigate complex knowledge bases and explore relationships between concepts, publications, authors, or experimental data. They thus facilitate an in-depth understanding and enrich one's knowledge.

These techniques may be applied to help healthcare professionals in quickly accessing up-to-date information about treatments, drug interactions, or care protocols, while ensuring transparency of sources.

These techniques may be used to organize and navigate through complex public data, such as infrastructures, public policies, or local initiatives, to facilitate transparency and decision-making.

These techniques may be used to enable teachers and learners to explore educational knowledge bases, facilitating dynamic and personalized learning experiences.

The present disclosure is not limited to the examples described above, which are provided solely by way of example, but encompasses all variations conceivable to those skilled in the art within the scope of the protection sought.

What is claimed is:

1. A method for presenting an answer to a question in natural language by a question-answering system, the method being implemented by a user interface and comprising:
presenting an answer to a question entered in natural language, the answer being generated by a question-answering engine using a natural language processing model;
presenting a representation of entities collected by the system during generation of the answer; and
presenting a representation of a knowledge graph portion comprising the entities collected and their neighborhood.

2. The method according to claim 1, wherein a presentation module is configured to present the answer progressively, as it is generated by the question-answering engine.

3. The method according to claim 1, wherein the representation of the entities collected comprises interactive links to pages detailing information associated with the entities.

4. The method according to claim 1, wherein the representation of the knowledge graph portion comprises interactive links to pages detailing information associated with the entities and their neighborhoods.

5. The method according to claim 3, wherein the pages comprise indications of the information sources.

6. The method according to claim 3, comprising a module for editing information on the pages.

7. The method according to claim 1, wherein the representation of the entities includes descriptive labels and/or text descriptions of the entities.

8. A question-answering system comprising a user interface, the user interface comprising:
a module for entering questions in natural language; and
a presentation module configured to present:
an answer generated by a question-answering engine using a natural language processing model;
a representation of entities collected by the system when generating the answer; and
a representation of a knowledge graph portion comprising the entities collected and their neighborhoods.

9. A non-transitory computer-readable storage medium storing one or more instructions for implementing the method according to claim 1 when the one or more instructions are executed by a processor.
